(19) United States
(12) Patent Application Publication
(10) Pub. No.: US 2016/0306330 A1
(43) Pub. Date: Oct. 20, 2016

(54) CONTROL PANEL APPARATUS WITH SHORT DISTANCE WIRELESS COMMUNICATION FUNCTION

(71) Applicant: Jogtek Corp., Taipei City (TW)

(72) Inventors: Wei-Chun HUANG, Taipei City (TW); Tsung-Hsing HSIEH, Taipei City (TW)

(21) Appl. No.: 14/688,608

(22) Filed: Apr. 16, 2015

(51) Int. Cl. G05B 15/02; H04W 4/00

(52) U.S. Cl. CPC G05B 15/02; H04W 4/008

(57) ABSTRACT

A control signal includes a schedule for turning on an electronic apparatus or turning off the electronic apparatus. A control signal generation unit sends the control signal to a portable apparatus side short distance wireless communication unit. The portable apparatus side short distance wireless communication unit converts the control signal into a wireless control signal. The portable apparatus side short distance wireless communication unit wirelessly sends the wireless control signal to a control panel apparatus side short distance wireless communication unit. The control panel apparatus side short distance wireless communication unit recoveries the wireless control signal as the control signal. The control panel apparatus side short distance wireless communication unit sends the control signal to a control unit. The control unit turns on the electronic apparatus or turns off the electronic apparatus according to the schedule of the control signal.

### BACKGROUND OF THE INVENTION

1. Field of the Invention

The present invention relates to a control panel apparatus, and especially relates to a control panel apparatus with a short distance wireless communication function.

2. Description of the Related Art

The control panel is a very common apparatus. The control panel is used to control electronic apparatuses, such as lamps. Therefore, the control panel is very important.

Currently, the operation of a related art control panel is inconvenient. The user has to operate the physical keys of the control panel to control the electronic apparatuses, such as setting the turning on time of the lamp.

Therefore, it is very important to design a control panel that can control the electronic apparatus conveniently.

### SUMMARY OF THE INVENTION

In order to solve the above-mentioned problems, an object of the present invention is to provide a control panel apparatus with a short distance wireless communication function.

In order to achieve the object of the present invention mentioned above, the control panel apparatus is applied to a portable apparatus and an electronic apparatus. The portable apparatus is wirelessly electrically connected to the control panel apparatus. The electronic apparatus is electrically connected to the control panel apparatus. The control panel apparatus comprises a control panel apparatus side short distance wireless communication unit and a control unit. The control panel apparatus side short distance wireless communication unit is wirelessly electrically connected to the portable apparatus. The control unit is electrically connected to the control panel apparatus side short distance wireless communication unit and the electronic apparatus. The portable apparatus comprises a portable apparatus side short distance wireless communication unit and a control signal generation unit. The portable apparatus side short distance wireless communication unit is wirelessly electrically connected to the control panel apparatus side short distance wireless communication unit. The control signal generation unit is electrically connected to the portable apparatus side short distance wireless communication unit. The control signal generation unit generates a control signal. The control signal comprises a schedule for turning on the electronic apparatus or turning off the electronic apparatus. After the control signal generation unit generates the control signal, the control signal generation unit sends the control signal to the portable apparatus side short distance wireless communication unit. After the portable apparatus side short distance wireless communication unit receives the control signal, the portable apparatus side short distance wireless communication unit converts the control signal into a wireless control signal. After the portable apparatus side short distance wireless communication unit converts the control signal into the wireless control signal, the portable apparatus side short distance wireless communication unit wirelessly sends the wireless control signal to the control panel apparatus side short distance wireless communication unit. After the control panel apparatus side short distance wireless communication unit receives the wireless control signal, the control panel apparatus side short distance wireless communication unit recoveries the wireless control signal as the control signal. After the control panel apparatus side short distance wireless communication unit recoveries the wireless control signal as the control signal, the control panel apparatus side short distance wireless communication unit sends the control signal to the control unit. After the control unit receives the control signal, the control unit turns on the electronic apparatus or turns off the electronic apparatus according to the schedule of the control signal.

Moreover, the control panel apparatus further comprises a control panel apparatus side antenna wirelessly electrically connected to the portable apparatus side short distance wireless communication unit and electrically connected to the control panel apparatus side short distance wireless communication unit.

Moreover, the portable apparatus further comprises a portable apparatus side antenna wirelessly electrically connected to the control panel apparatus side antenna and electrically connected to the portable apparatus side short distance wireless communication unit.

Moreover, the control panel apparatus further comprises a display unit electrically connected to the control unit.

Moreover, the control panel apparatus further comprises a physical key unit electrically connected to the control unit.

Moreover, the control panel apparatus side short distance wireless communication unit is, for example but not limited to, a near field communication circuit or a radio frequency identification communication circuit.

Moreover, the control unit is, for example but not limited to, a microcontroller or a microprocessor.

Moreover, the display unit is, for example but not limited to, a liquid crystal display or an electronic paper.

Moreover, the portable apparatus side short distance wireless communication unit is, for example but not limited to, a near field communication circuit or a radio frequency identification communication circuit.

Moreover, the electronic apparatus is, for example but not limited to, a lamp.

The advantage of the present invention is to transmit the schedule for turning on the electronic apparatus or turning off the electronic apparatus to the control panel according to the short distance wireless communication technology, so that the control panel turns on the electronic apparatus or turns off the electronic apparatus according to the schedule.

### BRIEF DESCRIPTION OF DRAWING

FIG. 1 shows a block diagram of the control panel apparatus of the present invention.

FIG. 2 shows a block diagram of the control panel apparatus side short distance wireless communication unit of the present invention.

### DETAILED DESCRIPTION OF THE INVENTION

Please refer to following detailed description and figures for the technical content of the present invention. The following detailed description and figures are referred for the present invention, but the present invention is not limited to it.

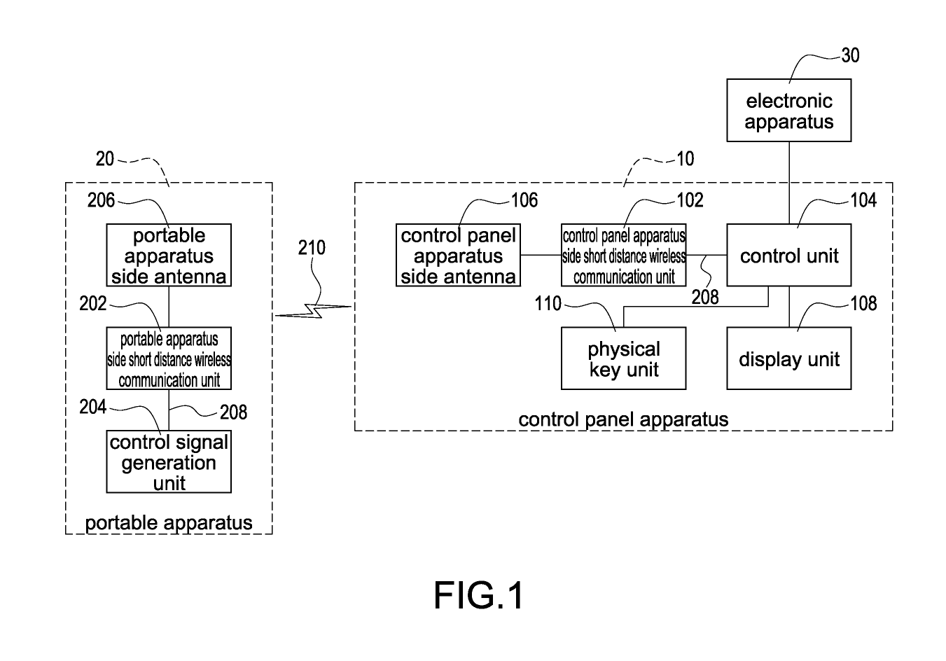

FIG. 1 shows a block diagram of the control panel apparatus of the present invention. A control panel apparatus 10 with a short distance wireless communication function is applied to a portable apparatus 20 and an electronic apparatus 30. The control panel apparatus 10 comprises a control panel apparatus side short distance wireless communication unit 102, a control unit 104, a control panel apparatus side antenna 106, a display unit 108 and a physical key unit 110. The portable apparatus 20 comprises a portable apparatus side short distance wireless communication unit 202, a control signal generation unit 204 and a portable apparatus side antenna 206.

The portable apparatus 20 is wirelessly electrically connected to the control panel apparatus 10. The electronic apparatus 30 is electrically connected to the control panel apparatus 10. The control panel apparatus side short distance wireless communication unit 102 is wirelessly electrically connected to the portable apparatus 20. The control unit 104 is electrically connected to the control panel apparatus side short distance wireless communication unit 102 and the electronic apparatus 30. The portable apparatus side short distance wireless communication unit 202 is wirelessly electrically connected to the control panel apparatus side short distance wireless communication unit 102. The control signal generation unit 204 is electrically connected to the portable apparatus side short distance wireless communication unit 202. The control panel apparatus side antenna 106 is wirelessly electrically connected to the portable apparatus side short distance wireless communication unit 202 and is electrically connected to the control panel apparatus side short distance wireless communication unit 102. The portable apparatus side antenna 206 is wirelessly electrically connected to the control panel apparatus side antenna 106 and is electrically connected to the portable apparatus side short distance wireless communication unit 202. The display unit 108 is electrically connected to the control unit 104. The physical key unit 110 is electrically connected to the control unit 104.

The control signal generation unit 204 generates a control signal 208. The control signal 208 comprises a schedule for turning on the electronic apparatus 30 or turning off the electronic apparatus 30. After the control signal generation unit 204 generates the control signal 208, the control signal generation unit 204 sends the control signal 208 to the portable apparatus side short distance wireless communication unit 202. After the portable apparatus side short distance wireless communication unit 202 receives the control signal 208, the portable apparatus side short distance wireless communication unit 202 converts the control signal 208 into a wireless control signal 210. After the portable apparatus side short distance wireless communication unit 202 converts the control signal 208 into the wireless control signal 210, the portable apparatus side short distance wireless communication unit 202 wirelessly sends the wireless control signal 210 through the portable apparatus side antenna 206 and the control panel apparatus side antenna 106 to the control panel apparatus side short distance wireless communication unit 102. After the control panel apparatus side short distance wireless communication unit 102 receives the wireless control signal 210, the control panel apparatus side short distance wireless communication unit 102 recoveries the wireless control signal 210 as the control signal 208. After the control panel apparatus side short distance wireless communication unit 102 recoveries the wireless control signal 210 as the control signal 208, the control panel apparatus side short distance wireless communication unit 102 sends the control signal 208 to the control unit 104. After the control unit 104 receives the control signal 208, the control unit 104 turns on the electronic apparatus 30 or turns off the electronic apparatus 30 according to the schedule of the control signal 208.

In an embodiment of the present invention, the user edits the schedule according to the application software on the portable apparatus 20. Then, the portable apparatus 20 is held by the user and closed to the control panel apparatus 10, so that the schedule is wirelessly sent to the control panel apparatus 10 according to the near field communication technology or the radio frequency identification communication technology. The schedule is to, for example but not limited to, turn on the lamp at 6 o'clock every Monday and at 7 o'clock every Tuesday.

The control panel apparatus side short distance wireless communication unit 102 is, for example but not limited to, a near field communication circuit, a radio frequency identification communication circuit, a dual interface memory circuit or a dynamic near field communication tag. The control unit 104 is, for example but not limited to, a microcontroller or a microprocessor. The display unit 108 is, for example but not limited to, a liquid crystal display or an electronic paper. The portable apparatus side short distance wireless communication unit 202 is, for example but not limited to, a near field communication circuit or a radio frequency identification communication circuit. The electronic apparatus 30 is, for example but not limited to, a lamp or a motor. The portable apparatus 20 is, for example but not limited to, a smart phone. An interface between the control panel apparatus side short distance wireless communication unit 102 and the control unit 104 is, for example but not limited to, an I2C, a serial peripheral interface (SPI) or a universal asynchronous receiver transmitter (UART).

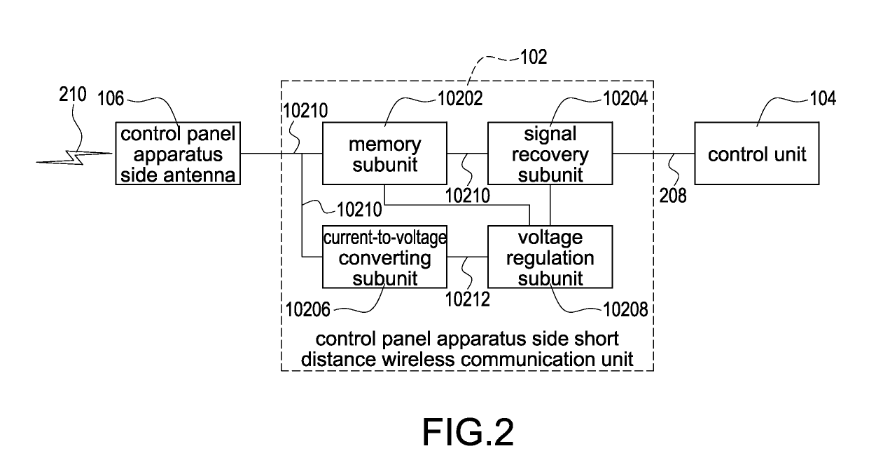

FIG. 2 shows a block diagram of the control panel apparatus side short distance wireless communication unit of the present invention. The control panel apparatus side short distance wireless communication unit 102 comprises a memory subunit 10202, a signal recovery subunit 10204, a current-to-voltage converting subunit 10206 and a voltage regulation subunit 10208.

The memory subunit 10202 is electrically connected to the control panel apparatus side antenna 106. The signal recovery subunit 10204 is electrically connected to the memory subunit 10202 and the control unit 104. The current-to-voltage converting subunit 10206 is electrically connected to the control panel apparatus side antenna 106 and the memory subunit 10202. The voltage regulation subunit 10208 is electrically connected to the memory subunit 10202, the signal recovery subunit 10204 and the current-to-voltage converting subunit 10206.

The control panel apparatus side antenna 106 induces the wireless control signal 210 as an induced current 10210. The induced current 10210 comprises the schedule. The control panel apparatus side antenna 106 sends the induced current 10210 to the memory subunit 10202. The memory subunit 10202 memorizes the induced current 10210. The memory subunit 10202 sends the induced current 10210 to the signal recovery subunit 10204. The signal recovery subunit 10204 obtains the control signal 208 according to the induced current 10210. The signal recovery subunit 10204 sends the control signal 208 to the control unit 104.

The control panel apparatus side antenna 106 sends the induced current 10210 to the current-to-voltage converting subunit 10206. The current-to-voltage converting subunit 10206 converts the induced current 10210 into an induced voltage 10212. The current-to-voltage converting subunit 10206 sends the induced voltage 10212 to the voltage regulation subunit 10208. The voltage regulation subunit 10208 provides the memory subunit 10202 and the signal recovery subunit 10204 with driving voltages.

The advantage of the present invention is to transmit the schedule for turning on the electronic apparatus or turning off the electronic apparatus to the control panel according to the short distance wireless communication technology, so that the control panel turns on the electronic apparatus or turns off the electronic apparatus according to the schedule.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A control panel apparatus applied to a portable apparatus and an electronic apparatus, the portable apparatus wirelessly electrically connected to the control panel apparatus, the electronic apparatus electrically connected to the control panel apparatus, the control panel apparatus comprising:
a control panel apparatus side short distance wireless communication unit wirelessly electrically connected to the portable apparatus; and
a control unit electrically connected to the control panel apparatus side short distance wireless communication unit and the electronic apparatus,
wherein the portable apparatus comprises:
a portable apparatus side short distance wireless communication unit wirelessly electrically connected to the control panel apparatus side short distance wireless communication unit; and
a control signal generation unit electrically connected to the portable apparatus side short distance wireless communication unit,
wherein the control signal generation unit generates a control signal; the control signal comprises a schedule for turning on the electronic apparatus or turning off the electronic apparatus; after the control signal generation unit generates the control signal, the control signal generation unit sends the control signal to the portable apparatus side short distance wireless communication unit; after the portable apparatus side short distance wireless communication unit receives the control signal, the portable apparatus side short distance wireless communication unit converts the control signal into a wireless control signal; after the portable apparatus side short distance wireless communication unit converts the control signal into the wireless control signal, the portable apparatus side short distance wireless communication unit wirelessly sends the wireless control signal to the control panel apparatus side short distance wireless communication unit; after the control panel apparatus side short distance wireless communication unit receives the wireless control signal, the control panel apparatus side short distance wireless communication unit recoveries the wireless control signal as the control signal; after the control panel apparatus side short distance wireless communication unit recoveries the wireless control signal as the control signal, the control panel apparatus side short distance wireless communication unit sends the control signal to the control unit; after the control unit receives the control signal, the control unit turns on the electronic apparatus or turns off the electronic apparatus according to the schedule of the control signal.

2. The control panel apparatus in claim 1, further comprising a control panel apparatus side antenna wirelessly electrically connected to the portable apparatus side short distance wireless communication unit and electrically connected to the control panel apparatus side short distance wireless communication unit.

3. The control panel apparatus in claim 2, wherein the portable apparatus further comprises a portable apparatus side antenna wirelessly electrically connected to the control panel apparatus side antenna and electrically connected to the portable apparatus side short distance wireless communication unit.

4. The control panel apparatus in claim 3, further comprising a display unit electrically connected to the control unit.

5. The control panel apparatus in claim 4, further comprising a physical key unit electrically connected to the control unit.

6. The control panel apparatus in claim 5, wherein the control panel apparatus side short distance wireless communication unit is a near field communication circuit or a radio frequency identification communication circuit.

7. The control panel apparatus in claim 5, wherein the control unit is a microcontroller or a microprocessor.

8. The control panel apparatus in claim 5, wherein the display unit is a liquid crystal display or an electronic paper.

9. The control panel apparatus in claim 5, wherein the portable apparatus side short distance wireless communication unit is a near field communication circuit or a radio frequency identification communication circuit.

10. The control panel apparatus in claim 5, wherein the electronic apparatus is a lamp.
